(19) United States
(12) Patent Application Publication
(10) Pub. No.: US 2024/0056641 A1
(43) Pub. Date: Feb. 15, 2024

(54) VIDEO PLAYING METHOD AND APPARATUS, DEVICE, AND MEDIUM

(71) Applicant: BEIJING BYTEDANCE NETWORK TECHNOLOGY CO., LTD., Beijing (CN)

(72) Inventor: Meiwa LI, Beijing (CN)

(21) Appl. No.: 18/267,446

(22) PCT Filed: Nov. 22, 2021
(86) PCT No.: PCT/CN2021/132063

§ 371 Date: Jun. 14, 2023

(30) Foreign Application Priority Data
Dec. 16, 2020 (CN) 202011487777.7

(51) Int. Cl. H04N 21/472; G06V 10/74; G06F 16/738; G06F 16/783

(52) U.S. Cl. CPC H04N 21/47217; G06V 10/761; G06F 16/738; G06F 16/783

(57) ABSTRACT

A video playing method and apparatus, a device, and a medium. The method is applied to a client, and comprises: receiving a short video to be played and playback information of a partner long video onto which the short video is mapped (101); and playing the short video, and jumping to a partner interface to play the partner long video based on the playback information of the partner long video (102). By adopting the technical solution, during the process of playing the short video, the client can jump to the partner interface to play the partner long video based on the playback information of the partner long video onto which the short video is mapped returned by a server, which improves the efficiency of attracting traffic for the partner long video through short videos since the short video can be mapped onto the partner long video quickly and accurately.

### CROSS REFERENCE TO RELATED APPLICATIONS

The disclosure claims priority to Chinese Patent Application No. 202011487777.7, field on Dec. 16, 2020, titled “VIDEO PLAYING METHOD AND APPARATUS, DEVICE, AND MEDIUM”, the entire contents of which are incorporated herein by reference.

### FIELD

The disclosure relates to the technical field of video playing, in particular to a video playing method and apparatus, a device, and a medium.

### BACKGROUND

With the constant development of an intelligent terminal and the network technology, different types of video contents have gradually become an important way to acquire information in daily life.

Short videos refer to high-frequency pushed video contents that are played on various media platforms and are suitable to watch in a mobile state and a short-time leisure state, and video lengths range from several seconds to several minutes. Long videos are different from short videos in video duration, and the video duration thereof generally is longer than half an hour. Currently, realization forms of short videos include modes of content rewards, content payment, advertisements, etc., and bringing in long videos of external partners by short videos is a novel realization form which can drive self-owned platform incomes and can lead flow for the external partners. At present, accuracy and efficiency do not meet the demand when attracting traffic for long videos of external partners based on short videos.

### SUMMARY

In order to solve the above technical problem or at least partially solve the above technical problem, the disclosure provides a video playing method and apparatus, a device, and a medium.

One embodiment of the disclosure provides a video playing method, comprising:
receiving a short video to be played and playback information of a partner long video onto which the short video is mapped; and
playing the short video, and jumping to a partner interface to play the partner long video based on the playback information of the partner long video.

One embodiment of the disclosure provides a video playing method, comprising:
determining playback information of a partner long video mapped onto a short video to be played; and
sending the short video and the playback information of the partner long video onto which the short video is mapped to a client, so that the client plays the short video and jumps to a partner interface to play the partner long video based on the playback information of the partner long video.

One embodiment of the disclosure provides a video playing apparatus, comprising:
an information receiving module, configured to receive a short video to be played and playback information of a partner long video onto which the short video is mapped; and
a video playing module, configured to play the short video, and jump to a partner interface to play the partner long video based on the playback information of the partner long video.

One embodiment of the disclosure provides a video playing apparatus, comprising:
an information determining module, configured to determine playback information of a partner long video mapped onto a short video to be played; and
an information sending module, configured to send the short video and the playback information of the partner long video onto which the short video is mapped to a client, so that the client plays the short video and jumps to a partner interface to play the partner long video based on the playback information of the partner long video.

One embodiment of the disclosure provides an electronic device, comprising: a processor; and a memory storing instructions executable by the processor; wherein the processor is configured to read the instructions from the memory and execute the instructions to perform the method according to any one of embodiments provided by the disclosure.

One embodiment of the disclosure provides a computer-readable storage medium, storing program instructions that upon execution by a computing device, cause the computing device to perform the method according to any one of embodiments provided by the disclosure.

The technical solutions provided by embodiments of the disclosure have the following advantages over the prior art: according to the video playing solution provided by the embodiments of the disclosure, a client receives a short video to be played and playback information of a partner long video onto which the short video is mapped, plays the short video, and jumps to a partner interface to play the partner long video based on the playback information of the partner long video. By means of the foregoing technical solution, the client can jump to the partner interface to play the partner long video based on the playback information of the partner long video onto which the short video is mapped returned by a server during the process of playing the short video, which improves the efficiency of attracting traffic for the partner long video through short videos since the short video can be mapped onto the partner long video quickly and accurately.

### BRIEF DESCRIPTION OF THE DRAWINGS

In combination with the drawings and with reference to the following specific implementation modes, the above-mentioned and other features, advantages, and aspects of each embodiment of the disclosure will become more obvious. Throughout the drawings, the same or similar reference signs represent the same or similar elements. It should be understood that the drawings are schematic, and components and elements are not always drawn proportionally.

FIG. 1 is a schematic flow diagram of a video playing method, as provided by an embodiment of the disclosure;

FIG. 2 is a schematic flow diagram of another video playing method, as provided by another embodiment of the disclosure;

FIG. 3 is a schematic diagram of a process of attracting traffic for a partner long video through a short video, as provided by an embodiment of the disclosure;

FIG. 4 is a schematic diagram of another process of attracting traffic for a partner long video through a short video, as provided by another embodiment of the disclosure;

FIG. 5 is a structural schematic diagram of a video playing apparatus, as provided by another embodiment of the disclosure;

FIG. 6 is a structural schematic diagram of another video playing apparatus, as provided by another embodiment of the disclosure; and

FIG. 7 is a structural schematic diagram of electronic device provided by an embodiment of the disclosure.

### DETAILED DESCRIPTION OF THE EMBODIMENTS

The embodiments of the disclosure will be described in more details with reference to the drawings. Some embodiments of the disclosure are shown in the drawings, but it should be understood that the disclosure may be implemented in various forms and should not be explained to be limited to the embodiments described herein, and on the contrary, these embodiments are provided for more thoroughly and completely understanding the disclosure. It should be understood that the drawings and the embodiments of the disclosure are merely used for the exemplary effect, but not used for limiting the scope of protection of the disclosure.

It should be understood that the steps described in the embodiments of the disclosure may be performed according to different orders and/or in parallel. In addition, the embodiments may include additional steps and/or omit the execution of the shown steps. The scope of the disclosure is not limited in this aspect.

The term “comprising” used herein and variants thereof means open-ended including, i.e., “including, but not limited to”. The term “based on” refers to “based at least in part on”. The term “one embodiment” represents “at least one embodiment”; the term “the other embodiment” represents “at least one additional embodiment”; and the term “some embodiments” represents “at least some embodiments”.

It should be noted that the terms such as “first”, “second” and the like mentioned in the disclosure are merely intended to distinguish different devices, modules, or units, rather than limiting an order of functions executed by these devices, modules or units or an interdependence among these devices, modules, or units.

It should be noted that the modifications of “a” and “multiple” mentioned in the disclosure are illustrative, but are not restrictive. It should be understood by those skilled in the art that it should be understood as “one or more” unless otherwise specified in the context.

Names of messages or information interacted among a plurality of devices in the embodiments of the disclosure are merely for an illustrative purpose, rather than limiting the scope of these messages or information.

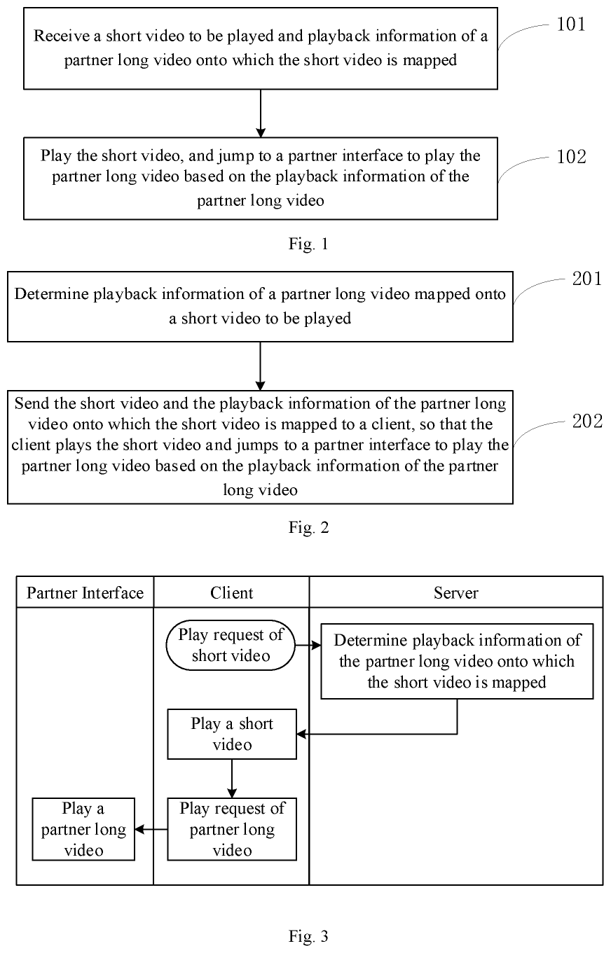

FIG. 1 is schematic flow diagram of a video playing method, as provided by an embodiment of the disclosure. The method may be performed by a video playing apparatus, wherein the apparatus may be implemented by adopting software and/or hardware, and generally may be integrated in electronic device. As shown in FIG. 1, the method is applied to a client and includes:

S101: receiving a short video to be played and playback information of a partner long video onto which the short video is mapped.

In one embodiment, the short video and the long video are relative concepts, generally, duration of the short video is shorter than that of the long video, and the short video may also be deemed as part of the long video, and the specific video duration is not limited. The short video to be played refers to a short video that are about to be played based on a current triggering operation of a user. The partner long video refers to a long video under the copyright of an external partner having a cooperative relationship with the client. And in one embodiment of the disclosure, the external partner provides media asset information, but does not provide specific video files.

In one embodiment of the disclosure, after being mapping onto the local long video, the short video is mapped onto the partner long video based on a pre-established association relationship between a local long video and the partner long video, wherein the local long video may be stored locally and licensed by different content providers, or from common resources, and the content providers may provide the media asset information and the video file of the local long video. Therefore, mapping between short videos and local long videos can be done based on video files (i.e., video matching), while mapping between short videos and partner long videos needs to be done through local long videos.

The playback information of the partner long video may include information required when the partner long video is played, and specifically, may include a playback address of the partner long video and a playback position of the partner long video.

Specifically, receiving the short video to be played and the playback information of the partner long video onto which the short video is mapped may include: sending a first video information acquisition request to a server based on a playing request of the user for the short video; and receiving the short video and the playback information of the partner long video onto which the short video is mapped fed back by the server are received. Optionally, receiving the short video to be played and the playback information of the partner long video onto which the short video is mapped may include: sending a second video information acquisition request to the server based on the playing request of the user for the short video; receiving the short video fed back by the server is received; sending a third video information acquisition request to the server in the process of playing the short video; and receiving the playback information of the partner long video onto which the short video is mapped fed back by the server.

If a triggering operation of the user for a preset key corresponding to the above short video is received, it can be determined that the playing request of the user for the short video is received; and based on the playing request, the server may be requested to return the short video and the playback information of the partner long video onto which the short video is mapped, or the server is only requested to return the short video, and in the process of playing the short video, if the playing request of the user for the partner long video onto which the short video is mapped is detected, the server is then requested to return the playback information of the partner long video onto which the short video is mapped. Namely, in the embodiment of the disclosure, a request opportunity for the short video and the playback information of the partner long video onto which the short video is mapped is not limited, all the requests may be obtained before the short video is played, or it may be that firstly, the short video is requested, and when needed, the playback information of the partner long video onto which the short video is mapped is requested, and thus, flexibility of acquiring the information is high.

S102: playing the short video is played, and jumping to a partner interface to play the partner long video based on the playback information of the partner long video.

In one embodiment, the partner interface includes a client of a partner having a cooperative relationship with the client currently being used, and the partner interface specifically may be launched in a form of a partner client (i.e., a partner application) or a partner H5 page in the current client.

Specifically, before jumping to the partner interface to play the partner long video based on the playback information of the partner long video, the method may further include: during the process of playing the short video, receiving a playing request of the user for the partner long video onto which the short video is mapped. In the process of playing the short video, if a triggering operation of the user for a key corresponding to the partner long video onto which the short video is mapped is received, it is determined that the playing request of the user for the partner long video is received, and then the partner interface can be launched to play the partner long video based on the playback information of the partner long video.

In the embodiment of the disclosure, jumping to the partner interface to play the partner long video based on the playback information of the partner long video may include: determining a page type and a page address of a partner long video playing page by parsing the playback information of the partner long video; based on the page type of the partner long video playing page, launching the partner interface in a form of the partner client or the partner H5 page within the client currently being used; and sending the page address of the partner long video playing page and the playback information of the partner long video to the partner interface, so that the partner interface plays the partner long video based on the page address of the partner long video playing page and the playback information of the partner long video.

The playback information of the partner long video may include a playback address of the partner long video and a playback position of the partner long video, the playback position of the partner long video refers to a specific position from which the partner long video should be played after it is introduced by the short video. For example, the long video can be played from the current playback position of the short video. By parsing the playback address of the partner long video, the page type and the page address of the partner long video playing page can be obtained. The page type may be understood as a Uniform Resource Locator Scheme (URL Scheme), the page type of the partner long video playing page corresponds to a specific form of the partner interface, and for example, if the page type is “HTTP”, the partner interface is launched in the form of the H5 page, and if the page type is a partner customized protocol, the partner interface is launched in a form of the partner client.

Based on the page type of the partner long video playing page, a launching request may be sent to the partner interface, the partner interface is launched, and the page address of the partner long video playing page and the playback position of the partner long video can also be added into the launching request to be sent to the partner interface. The partner interface receives a launching instruction, the page address of the partner long video playing page and the playback position of the partner long video, and plays the partner long video after being launched.

According to a video playing solution provided by the embodiment of the disclosure, the client receives the short video to be played and the playback information of the partner long video onto which the short video is mapped, plays the short video, and jumps to the partner interface to play the partner long video based on the playback information of the partner long video. By means of the foregoing technical solution, the client can jump to the partner interface to play the partner long video based on the playback information of the partner long video onto which the short video is mapped returned by a server during the process of playing the short video, which improves the efficiency of attracting traffic for the partner long video through short videos since the short video can be mapped onto the partner long video quickly and accurately. And continuous play can be performed based on the specific playback position of the short video in the partner long video, so that the partner long video can be continued to play seamlessly, thereby improving the user experience.

FIG. 2 is a schematic flow diagram of another video playing method, as provided by an embodiment of the disclosure. The method may be performed by a video playing apparatus, wherein the apparatus may be implemented by adopting software and/or hardware, and generally may be integrated in electronic device. As shown in FIG. 2, the method is applied to a server and includes:

S201: playback information of a partner long video mapped onto a short video to be played is determined.

After the server receives a video information acquisition request sent by a client, based on a short video identifier of the short video to be played in the video information acquisition request, the short video can be acquired and the playback information of the partner long video onto which the short video is mapped can be determined, wherein the short video identifier may be a short video ID and is not limited specifically.

In the embodiment of the disclosure, determining the playback information of the partner long video mapped onto the short video to be played may include: determining mapping information of the short video in a partner long video album based on mapping information of the short video in a local long video album and a first episode association relationship between the local long video album and the partner long video album; and determining the playback information of the partner long video onto which the short video is mapped based on the mapping information of the short video in the partner long video album, wherein the mapping information of the short video in the partner long video album includes an episode to which the short video belongs in the partner long video album and a position in the episode, and a long video corresponding to the episode, to which the short video belongs, in the partner long video album is the partner long video.

After the short video is acquired, matching can be performed in the local long video album based on the short video so as to acquire the mapping information of the short video in the local long video album. Specifically, the short video is matched in a plurality of local long video albums based on a video frame matching mode, each matching degree is calculated, the local long video album with the highest matching degree is determined, and an episode, to which the short video belongs, in the local long video album with the highest matching degree and a position in the episode are acquired. Then, based on the mapping information of the short video in the local long video album and a first episode association relationship between the local long video album and the partner long video album, the mapping information of the short video in the partner long video album is acquired. Specifically, based on the episode, to which the short video belongs, in the local long video album and the position in the drama, searching is carried out in the first episode association relationship between the local long video album and the partner long video album so as to determine the episode, to which the short video belongs, in the partner long video album and/or the position in the episode to which the short video belongs, in the partner long video album.

In addition, both the local long video album and the partner long video album are associated with a video resource identifier which may be understood as an aggregation identifier of media asset information of a local video album and a partner video album belonging to the same video resource. When the first episode association relationship is not established between a current local long video album onto which the short video is mapped and the partner long video album and the first episode association relationship is pre-established between the partner long video album and another local long video album under the video resource identifier, wherein the current local long video album is referred to as a first local long video album and another local long video album is referred to as a second local long video album, the acquiring the mapping information of the short video in the partner long video album may include: based on the video resource identifier associated with the current local long video album, determining the second local long video album having a second episode association relationship with the current local long video album; and based on the mapping information of the short video in the local long video album, the second episode association relationship between the first local long video album and the second local long video album, and the first episode association relationship between the second local long video album and the partner long video album, acquiring the mapping information of the short video in the partner long video album.

In this case, after mapping of the short video and the local long video album, if the episode association relationship is pre-established between the local long video album and the partner long video album, mapping of the short video and the partner long video album can be implemented; but if the local long video album is not associated with the partner long video album, another local long video album associated with the partner long video album can be searched based on the video resource identifier associated with the local long video album, and mapping of the short video and the partner long video album can be implemented by an episode association relationship between the another local long video album and the local long video album. The short video can rapidly be mapped with the partner long video so as to avoid a mapping failure caused by a low matching degree and improve the accuracy and the convenience, thereby improving the efficiency of subsequently attracting traffic for the partner long video through the short video.

The playback information of the partner long video may include a playback address of the partner long video and a playback position of the partner long video, and determining the playback address of the partner long video based on the mapping information of the short video in the partner long video album may include: determining the playback address of the partner long video based on the episode, to which the short video belongs, in the partner long video album and media asset information of the partner long video album. Based on the drama, to which the short video belongs, in the partner long video album, searching can be carried out in the media asset information of the partner long video album so as to determine that a playback address corresponding to the drama is the playback address of the partner long video.

The media asset information refers to information such as description information and copyright information related to a video album, and specifically may include album information and episode information. The album information refers to information related to the entire video album, and specifically may include an album identifier, the number of dramas, an album introduction, payment information and a payment type or other descriptive information about the album, wherein the album introduction may include information such as country of producer, actors, and directors. The episode information may include information related to each episode, and specifically may include the number of episodes of the drama, a drama identifier, drama duration, a playback address or other descriptive information about the episode.

Determining the playback position of the partner long video based on the mapping information of the short video in the partner long video album includes: determining a matching degree between the short video and the partner long video; and determining the playback position of the partner long video based on the matching degree between the short video and the partner long video and the position of the short video in the partner long video. Determining the matching degree between the short video and the partner long video may include: determining a local long video matched with the partner long video; and determining a matching degree between the short video and the local long video as the matching degree between the short video and the partner long video. The local long video matched with the partner long video refers to a long video corresponding to the episode, to which the short video belongs, in the local long video album. The short video is matched with the local long video album first and the matching degree between the short video and the local long video has been determined previously, and thus, the matching degree can be determined as the matching degree between the short video and the partner long video.

Determining the playback position of the partner long video based on the matching degree between the short video and the partner long video and the position of the short video in the partner long video includes: if the matching degree between the short video and the partner long video is greater than or equal to a matching degree threshold, determining the playback position of the partner long video as a position after an initial position of the short video in the partner long video and separated from the initial position by the length of time that the short video has been played; or determining the playback position of the partner long video as the initial position of the short video in the partner long video, wherein the matching degree threshold may be set according to actual situations, and for example, the matching degree threshold may be set as 90%. If the matching degree between the short video and the partner long video is greater than or equal to the matching degree threshold, it means that accurate continuous play of the partner long video can be performed, and the playback position of the partner long video is set as the sum of the initial position of the short video in the position of the partner long video and a length of the time played of the short video. Otherwise, it means that the matching degree is relatively low and accurate continuous playing is difficult to implement, so the playback position of the partner long video can be set as the initial position of the short video in the partner long video. The length of time the short video has been played may be sent to the server after being detected and determined by the client.

Exemplarily, it is assumed that the matching degree threshold is 90%, the position of the short video in the partner long video is from the third minute to the thirteenth minute (00:03:00-00:13:00), and the time played of the short video is 2 minutes, and if the matching degree is greater than 90%, the playback position of the partner long video may be the fifth minute (00:05:00), or the playback position of the partner long video may be the third minute (00:03:00).

S202: the short video and the playback information of the partner long video onto which the short video is mapped are sent to the client, so that the client plays the short video and jumps to a partner interface to play the partner long video based on the playback information of the partner long video.

The video information acquisition request may be a first video information acquisition request, or may include a second video information acquisition request and a third video information acquisition request. The first video information acquisition request may be understood as a request configured to simultaneously acquire the short video and the playback information of the partner long video onto which the short video is mapped, the second video information acquisition request refers to a request configured to only acquire the short video, and the third video information acquisition request refers to a request configured to only acquire the playback information of the partner long video onto which the short video is mapped.

Specifically, sending the short video and the playback information of the partner long video onto which the short video is mapped to the client may include: based on the first video information acquisition request sent by the client, sending the short video and the playback information of the partner long video onto which the short video is mapped to the client. Or, sending the short video and the playback information of the partner long video onto which the short video is mapped to the client may include: based on the second video information acquisition request sent by the client, sending the short video to the client; and based on the third video information acquisition request sent by the client in the process of playing the short video, sending the playback information of the partner long video onto which the short video is mapped to the client. Namely, in the embodiment of the disclosure, the server may feedback both the short video and the playback information of the partner long video onto which the short video is mapped to the client based on the first request of the client, or may firstly feedback the short video based on the first request, and then feedback the playback information of the partner long video onto which the short video is mapped based on the second request.

After the server sends the short video and the playback information of the partner long video onto which the short video is mapped to the client, the client can play the short video, and in the process of playing the short video, when receiving the playing request of the user for the partner long video onto which the short video is mapped, the client performs the step of jumping to the partner interface to play the partner long video based on the playback information of the partner long video.

Exemplarily, FIG. 3 is a schematic diagram of a process of attracting traffic for a partner long video by a short video, as provided by an embodiment of the disclosure. With reference to FIG. 3, the specific process may be as follows: a user triggers a playing request for the short video, and a client accesses a server; the server can search out a partner long video album corresponding to the short video and episode information thereof according to a warehoused mapping relationship in a background, wherein the long video corresponding to the episode is the partner long video, so that playback information of the partner long video onto which the short video is mapped is determined; the client plays the short video, and based on an entrance of the shown partner long video, when the user clicks on the entrance, the playing request of the user for the partner long video is received; the client jumps to a partner interface based on the playback information of the partner long video; and the partner interface plays the partner long video.

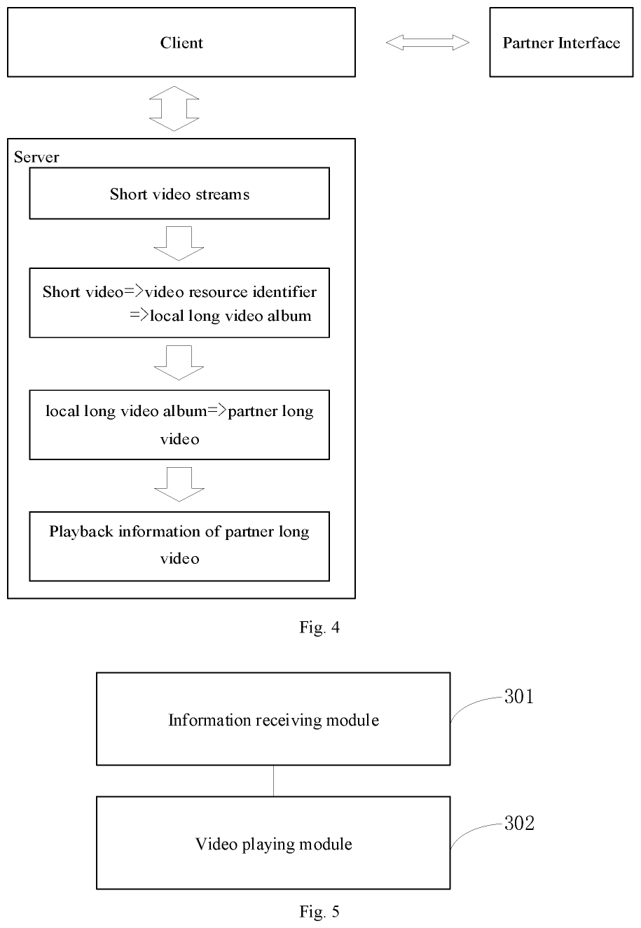

FIG. 4 is a schematic diagram of another process of attracting traffic for a partner long video by a short video, as provided by an embodiment of the disclosure. A client can send a video information acquisition request to a server based on a playing request of a user for the short video; the server can provide short video streams, map the short video onto a local long video album, map the short video onto a video resource identifier corresponding to the local long video album, then map the short video onto a partner long video album based on a first episode association relationship between the local long video album and the partner long video album, and acquire playback information of the partner long video; the server can feed back a video file of the short video and the playback information of the partner long video onto which the short video is mapped to the client; and the client plays the short video and jumps to a partner interface based on the playback information of the partner long video onto which the short video is mapped so as to play the partner long video.

According to the video playing method, which is provided by the embodiments of the disclosure, the time to find a relevant long video under corresponding long video episodes can be shortened in the short video watching scenario, and user experience can be improved. For example, when users watch short videos in a current client, they need to exit the client and open up other long video clients to search, select episodes, and fast forward the relevant long video to a specified playback position. But in the embodiments of the disclosure, the above process is shortened into a process that when watching a short video at the current client, the user can directly click on buttons of “full edition” and the like which identify an access to a partner long video watching entrance so that the current client can jump to a corresponding partner client to play the partner long video from the point at which the user left off the short video. In addition, the embodiment of the disclosure can solve the problem that when a certain content is only entitled to be played by a certain client, it will take a long time for the user to find the content.

According to the video playing solution provided by the embodiments of the disclosure, the server determines the playback information of the partner long video mapped onto the short video to be played and sends the short video and the playback information of the partner long video onto which the short video is mapped to the client, so that the client can play the short video and jump to the partner interface based on the playback information of the partner long video to play the partner long video. By means of the foregoing technical solution, the server, based on a request of the short video, can rapidly and accurately determine the playback information of the partner long video mapped onto the short video to be played based on an established mapping relationship, so that the client can rapidly attract traffic for the partner long video based on the short video, thereby improving the efficiency and accuracy of attracting traffic for the partner long video by the short video. And continuous play can be performed based on the specific playback position of the short video in the partner long video, so that the partner long video can be continued to play seamlessly, thereby improving the user experience.

FIG. 5 is a structural schematic diagram of a video playing apparatus, as provided by an embodiment of the disclosure. The apparatus can be implemented by software and/or hardware, generally can be integrated in electronic device, and can implement an effect of attracting traffic for a partner long video based on a short video by performing the video playing method. As shown in FIG. 5, the apparatus is arranged in a client, and includes:
an information receiving module 301, configured to receive a short video to be played and playback information of a partner long video onto which the short video is mapped; and
a video playing module 302, configured to play the short video, and jump to a partner interface to play the partner long video based on the playback information of the partner long video.

In one embodiment, the information receiving module 301 is specifically configured to:
send a first video information acquisition request to a server based on a playing request of a user for the short video; and
receive the short video and the playback information of the partner long video onto which the short video is mapped fed back by the server.

In one embodiment, the information receiving module 301 is specifically configured for:
send a second video information acquisition request to a server based on a playing request of a user for the short video;
receive the short video fed back by the server;
send a third video information acquisition request to the server in the process of playing the short video; and
receive the playback information of the partner long video onto which the short video is mapped fed back by the server.

In one embodiment, the apparatus further comprises a partner long video play trigger module, configured to:
in the process of playing the short video, receive a playing request of a user for the partner long video onto which the short video is mapped.

In one embodiment, the playback information of the partner long video comprises a playback address of the partner long video and a playback position of the partner long video.

In one embodiment, the video playing module 302 is specifically configured for:
determining a page type and a page address of a partner long video playing page by parsing the playback information of the partner long video;
based on the page type of the partner long video playing page, launching the partner interface in a form of a partner client or a partner H5 page within a client currently being used; and
sending the page address of the partner long video playing page and the playback information of the partner long video to the partner interface, so that the partner interface plays the partner long video based on the page address of the partner long video playing page and the playback information of the partner long video.

The video playing apparatus provided by the embodiment of the disclosure, which is configured in a server, determines the playback information of the partner long video mapped onto the short video to be played, and sends the short video and the playback information of the partner long video onto which the short video is mapped to a client, so that the client plays the short video and jumps to a partner interface to play the partner long video based on the playback information of the partner long video. By means of the foregoing technical solution, the client can jump to the partner interface to play the partner long video based on the playback information of the partner long video onto which the short video is mapped returned by a server during the process of playing the short video, which improves the efficiency of attracting traffic for the partner long video through short videos since the short video can be mapped onto the partner long video quickly and accurately. And continuous play can be performed based on the specific playback position of the short video in the partner long video, so that the partner long video can be continued to play seamlessly, thereby improving the user experience.

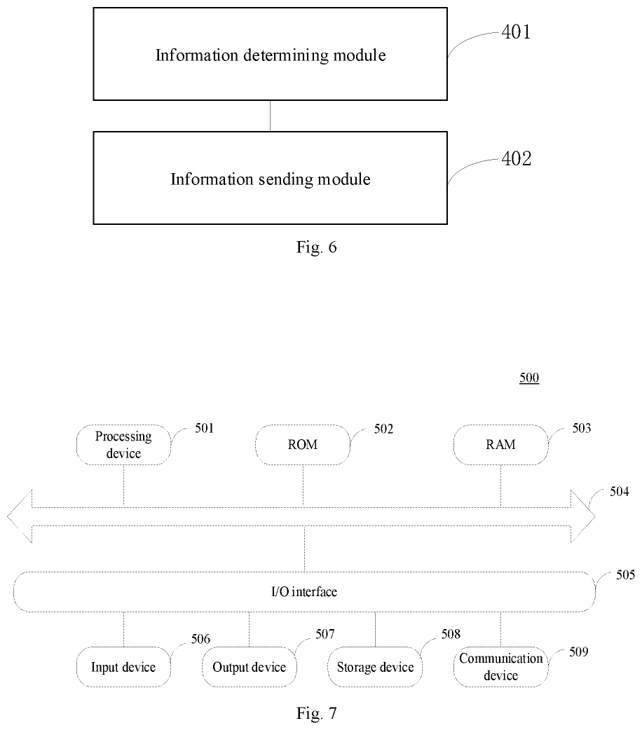

FIG. 6 is a structural schematic diagram of a video playing apparatus, as provided by another embodiment of the disclosure. The apparatus can be implemented by software and/or hardware, generally can be integrated in electronic device, and can implement an effect of attracting traffic for a partner long video based on a short video by performing the video playing method. As shown in FIG. 6, the apparatus is arranged in a server, and includes:
an information determining module 401, configured to determine playback information of a partner long video mapped onto a short video to be played; and
an information sending module 402, configured to send the short video and the playback information of the partner long video onto which the short video is mapped to a client, so that the client plays the short video and jumps to a partner interface to play the partner long video based on the playback information of the partner long video.

In one embodiment, the information sending module 402 is specifically configured for:
based on a first video information acquisition request sent by the client, sending the short video and the playback information of the partner long video onto which the short video is mapped to the client.

In one embodiment, the information sending module 402 is specifically configured for:
based on a second video information acquisition request sent by the client, sending the short video to the client; and
based on a third video information acquisition request sent by the client in the process of playing the short video, sending the playback information of the partner long video onto which the short video is mapped to the client.

In one embodiment, information determining module 401 comprises:
a mapping information module, configured to determine mapping information of the short video in a partner long video album based on mapping information of the short video in a local long video album and a first episode association relationship between the local long video album and the partner long video album; and
a playback information module, configured to determine the playback information of the partner long video onto which the short video is mapped based on the mapping information of the short video in the partner long video album.

In one embodiment, the mapping information of the short video in the partner long video album comprises an episode, to which the short video belongs, in the partner long video album and a position in the episode, and wherein a long video corresponding to the episode, to which the short video belongs, in the partner long video album is the partner long video.

In one embodiment, the playback information of the partner long video comprises a playback address of the partner long video and a playback position of the partner long video; and the playback information module comprises a playback address sub-module, configured for:
determining the playback address of the partner long video based on the episode, to which the short video belongs, in the partner long video album and media asset information of the partner long video album, and
the playback information module comprises a playback position sub-module, configured for:
determining the playback position of the partner long video based on the mapping information of the short video in the partner long video album, which comprises:
determining a matching degree between the short video and the partner long video, and
determining the playback position of the partner long video based on the matching degree between the short video and the partner long video and the position of the short video in the partner long video.

In one embodiment, the playback position sub-module is specifically configured for:
if the matching degree between the short video and the partner long video is greater than or equal to a matching degree threshold, determining the playback position of the partner long video as a position after an initial position of the short video in the partner long video and separated from the initial position by a length of time the short video has been played; or
determining the playback position of the partner long video as the initial position of the short video in the partner long video.

In one embodiment, the playback position sub-module is specifically configured for:
determining a local long video matched with the partner long video; and
determining a matching degree between the short video and the local long video as the matching degree between the short video and the partner long video.

In one embodiment, in the process of playing the short video by the client, when a request of the user for playing the partner long video onto which the short video is mapped is received, the step of jumping to the partner interface to play the partner long video based on the playback information of the partner long video is performed.

The video playing apparatus provided by the embodiments of the disclosure, which arranged in a server, determines the playback information of the partner long video mapped onto the short video to be played and sends the short video and the playback information of the partner long video onto which the short video is mapped to the client, so that the client can play the short video and jump to the partner interface based on the playback information of the partner long video to play the partner long video. By means of the foregoing technical solution, the server, based on a request of the short video, can rapidly and accurately determine the playback information of the partner long video mapped onto the short video to be played based on an established mapping relationship, so that the client can rapidly attract traffic for the partner long video based on the short video, thereby improving the efficiency and accuracy of attracting traffic for the partner long video by the short video. And continuous play can be performed based on the specific playback position of the short video in the partner long video, so that the partner long video can be continued to play seamlessly, thereby improving the user experience.

Referring now to FIG. 7, a structural schematic diagram of electronic device 500 (such as the server shown in FIG. 1) suitable for implementing an embodiment of the disclosure is shown. The terminal equipment in the embodiment of the present disclosure can include, but is not limited to, mobile terminals such as a mobile phone, a notebook computer, a digital broadcast receiver, a personal digital assistant (PDA), a Pad, a portable media player (PMP) and a vehicle-mounted terminal (e.g., vehicle-mounted navigation terminal), and fixed terminals such as a digital TV and a desktop computer. The electronic device shown in FIG. 7 is only an example, and should not bring any restrictions on the functions and application scope of the embodiments of the present disclosure.

As shown in FIG. 7, the electronic device 500 can comprise a processing device (e.g., central processing unit, graphics processor, etc.) 501, which can perform various appropriate actions and processing according to a program stored in a read-only memory (ROM) 502 or a program loaded into a random-access memory (RAM) 503 from a storage device 508. In the RAM 503, various programs and data required for the operation of the electronic device 500 are also stored. The processing device 501, the ROM 502, and the RAM 503 are connected through a bus 504. An Input/Output (I/O) interface 505 is also connected to the bus 504.

Generally, the following devices can be connected to the I/O interface 505: an input device 506 such as a touch screen, a touch pad, a keyboard, a mouse, a camera, a microphone, an accelerometer, and a gyroscope; an output device 507 such as a liquid crystal display (LCD), a speaker and a vibrator; a storage device 508 such as a magnetic tape and a hard disk; and a communication device 509. The communication device 509 can allow the electronic device 500 to perform wireless or wired communication with other equipment to exchange data. Although FIG. 7 shows the electronic device 500 with various devices, it should be understood that it is not required to implement or provide all the devices shown. More or fewer devices may alternatively be implemented or provided.

Particularly, according to the embodiments of the disclosure, the processes described above with reference to the flowcharts may be implemented as computer software programs. For example, the embodiments of the disclosure comprise a computer program product comprising a computer program carried by a computer-readable medium, and the computer program contains program codes for executing the method shown in the flowcharts. In such embodiment, the computer program can be downloaded and installed from a network through the communication device 509, or installed from the storage device 508, or installed from the ROM 502. When the computer program is executed by the processing device 501, the above functions defined in the method of the embodiments of the disclosure are executed.

It should be noted that the above-mentioned computer-readable medium can be a computer-readable signal medium or a computer-readable storage medium or any combination of the two. The computer-readable storage medium may be, for example, but not limited to, an electrical, magnetic, optical, electromagnetic, infrared or semiconductor system, device or component, or any combination of the above. More specific examples of the computer-readable storage medium may include, but are not limited to, an electrical connector with one or more wires, a portable computer disk, a hard disk, an RAM, an ROM, an electrically erasable programmable read only memory (EPROM) or flash memory, an optical fiber, a portable compact disc read-only memory (CD-ROM), an optical storage device, a magnetic storage device, or any suitable combination of the above. In the disclosure, the computer-readable storage medium can be any tangible medium containing or storing a program, which can be used by or in combination with an instruction execution system, device, or component. In the disclosure, the computer-readable signal medium can comprise a data signal propagated in a baseband or as part of a carrier wave, in which computer-readable program codes are carried. This propagated data signal can take various forms, including but not limited to an electromagnetic signal, an optical signal, or any suitable combination of the above. The computer-readable signal medium can also be any computer-readable medium other than the computer-readable storage medium, and the computer-readable signal medium can send, propagate, or transmit the program for use by or in connection with the instruction execution system, device, or component. The program codes contained in the computer-readable medium can be transmitted by any suitable medium, including but not limited to electric wire, optical cable, radio frequency (RF) or any suitable combination of the above.

In some embodiments, the client and the server can use any currently known or future developed network protocols such as HTTP (HyperText Transfer Protocol) to communicate, and can communicate with any form or medium digital data communications (e.g., communications networks) interconnected. Examples of communication networks include local area networks (“LAN”), wide area networks (“WAN”), the Internet, and peer-to-peer networks (e.g., ad hoc peer-to-peer networks), as well as any currently known or future developed network.

The above computer-readable medium may be included in the above electronic device or may be present separately and not assembled into that electronic device.

The above computer-readable medium stores program instructions that upon execution by the electronic device, cause the electronic device to: receive a short video to be played and playback information of a partner long video onto which the short video is mapped; and play the short video, and jumping to a partner interface to play the partner long video based on the playback information of the partner long video.

Or the above computer-readable medium stores program instructions that upon execution by the electronic device, cause the electronic device to: determine playback information of a partner long video mapped onto a short video to be played, and send the short video and the playback information of the partner long video onto which the short video is mapped to a client, so that the client plays the short video and jumps to a partner interface to play the partner long video based on the playback information of the partner long video.

Computer program codes for performing the operations of the disclosure can be written in one or more programming languages or a combination thereof, including object-oriented programming languages such as JAVA®, SMALLTALK®, C++, and conventional procedural programming languages such as “C” language or similar programming languages. The program code can be completely or partially executed on a user computer, executed as an independent software package, partially executed on a user computer, and partially executed on a remote computer, or completely executed on a remote computer or server. In a case involving a remote computer, the remote computer can be connected to a user computer through any kind of network including a local area network (LAN) or a wide area network (WAN), or can be connected to an external computer (e.g., connected through the Internet using an Internet service provider).

The flowcharts and block diagrams in the drawings show the architectures, functions, and operations of possible implementations of systems, methods, and computer program products according to various embodiments of the disclosure. In this regard, each block in the flowchart or block diagram can represent a module, a program segment or part of a code that contains one or more executable instructions for implementing a specified logical function. It should also be noted that in some alternative implementations, the functions noted in the blocks can also occur in a different order from those noted in the drawings. For example, two consecutive blocks can actually be executed in substantially parallel, and sometimes they can be executed in reverse order, depending on the functions involved. It should also be noted that each block in the block diagrams and/or flowcharts, and combinations of blocks in the block diagrams and/or flowcharts, can be implemented with dedicated hardware-based systems that perform specified functions or actions, or can be implemented with combinations of dedicated hardware and computer instructions.

The modules or units described in the embodiments of the disclosure can be implemented by software or hardware. The name of a module or unit does not constitute a limitation to the module or unit itself under certain circumstances.

The functions described herein above may be performed, at least in part, by one or more hardware logic components. For example, exemplary types of hardware logic components that may be used include: Field Programmable Gate Arrays (FPGAs), Application Specific Integrated Circuits (ASICs), Application Specific Standard Products (ASSPs), Systems on Chips (SOCs), Complex Programmable Logical Devices (CPLDs) and etc.

In the context of the present disclosure, a machine-readable medium may be a tangible medium that may contain or store programs for use by or in combination with an instruction execution system, device, or device. The machine-readable medium may be a machine-readable signal medium or a machine-readable storage medium. Machine readable media may include, but are not limited to, electronic, magnetic, optical, electromagnetic, infrared, or semiconductor systems, devices or devices, or any suitable combination of the above. More specific examples of machine-readable storage media will include electrical connections based on one or more lines, portable computer disks, hard disks, random access memory (RAM), read only memory (ROM), erasable programmable read only memory (EPROM or flash memory), optical fibers, portable compact disk read only memory (CD-ROM), optical storage devices, magnetic storage devices or any suitable combination of the above.

In one embodiment, the disclosure provides a video playing method, applied to a client, comprising:
receiving a short video to be played and playback information of a partner long video onto which the short video is mapped; and
playing the short video, and jumping to a partner interface to play the partner long video based on the playback information of the partner long video.

In the method provided by one or more embodiments, the receiving a short video to be played and playback information of the partner long video onto which the short video is mapped comprises:
sending a first video information acquisition request to a server based on a playing request of a user for the short video; and
receiving the short video and the playback information of the partner long video onto which the short video is mapped fed back by the server.

In the method provided by one or more embodiments, the receiving a short video to be played and playback information of the partner long video onto which the short video is mapped comprises:
sending a second video information acquisition request to a server based on a playing request of a user for the short video;
receiving the short video fed back by the server;
sending a third video information acquisition request to the server in the process of playing the short video; and
receiving the playback information of the partner long video onto which the short video is mapped fed back by the server.

In one embodiment, before the jumping to a partner interface to play the partner long video based on the playback information of the partner long video, the method further comprises:
in the process of playing the short video, receiving a playing request of a user for the partner long video onto which the short video is mapped.

In the method provided by one or more embodiments, the playback information of the partner long video comprises a playback address of the partner long video and a playback position of the partner long video.

In the method provided by one or more embodiments, the jumping to a partner interface to play the partner long video based on the playback information comprises:
determining a page type and a page address of a partner long video playing page by parsing the playback information of the partner long video;
based on the page type of the partner long video playing page, launching the partner interface in a form of a partner client or a partner H5 page within a client currently being used; and
sending the page address of the partner long video playing page and the playback information of the partner long video to the partner interface, so that the partner interface plays the partner long video based on the page address of the partner long video playing page and the playback information of the partner long video.

In one embodiment, the disclosure provides a video playing method, comprising:
determining playback information of a partner long video mapped onto a short video to be played; and
sending the short video and the playback information of the partner long video onto which the short video is mapped to a client, so that the client plays the short video and jumps to a partner interface to play the partner long video based on the playback information of the partner long video.

In the method provided by one or more embodiments, the sending the short video and the playback information of the partner long video onto which the short video is mapped to a client comprises:
based on a first video information acquisition request sent by the client, sending the short video and the playback information of the partner long video onto which the short video is mapped to the client.

In the method provided by one or more embodiments, the sending the short video and the playback information of the partner long video onto which the short video is mapped to a client comprises:
based on a second video information acquisition request sent by the client, sending the short video to the client; and
based on a third video information acquisition request sent by the client in the process of playing the short video, sending the playback information of the partner long video onto which the short video is mapped to the client.

In the method provided by one or more embodiments, the determining playback information of a partner long video mapped onto a short video to be played comprises:
determining mapping information of the short video in a partner long video album based on mapping information of the short video in a local long video album and a first episode association relationship between the local long video album and the partner long video album; and
determining the playback information of the partner long video onto which the short video is mapped based on the mapping information of the short video in the partner long video album.

In the method provided by one or more embodiments, wherein the mapping information of the short video in the partner long video album comprises an episode, to which the short video belongs, in the partner long video album and a position in the episode, and wherein a long video corresponding to the episode, to which the short video belongs, in the partner long video album is the partner long video.

In the method provided by one or more embodiments, the playback information of the partner long video comprises a playback address of the partner long video and a playback position of the partner long video;
and determining the playback address of the partner long video based on the mapping information of the short video in the partner long video album comprises:
determining the playback address of the partner long video based on the episode, to which the short video belongs, in the partner long video album and media asset information of the partner long video album; and
determining the playback position of the partner long video based on the mapping information of the short video in the partner long video album comprises:
determining a matching degree between the short video and the partner long video, and
determining the playback position of the partner long video based on the matching degree between the short video and the partner long video and the position of the short video in the partner long video.

In the method provided by one or more embodiments, the determining the playback position of the partner long video based on the matching degree between the short video and the partner long video and the position of the short video in the partner long video comprises:
if the matching degree between the short video and the partner long video is greater than or equal to a matching degree threshold, determining the playback position of the partner long video as a position after an initial position of the short video in the partner long video and separated from the initial position by a length of time the short video has been played; or
determining the playback position of the partner long video as the initial position of the short video in the partner long video.

In the method provided by one or more embodiments, the determining a matching degree between the short video and the partner long video comprises:
determining a local long video matched with the partner long video; and
determining a matching degree between the short video and the local long video as the matching degree between the short video and the partner long video.

In the method provided by one or more embodiments, in the process of playing the short video by the client, when a request of the user for playing the partner long video onto which the short video is mapped is received, the step of jumping to the partner interface to play the partner long video based on the playback information of the partner long video is performed.

In one embodiment, the disclosure provides a video playing apparatus, arranged in a client, comprising:
an information receiving module, configured to receive a short video to be played and playback information of a partner long video onto which the short video is mapped; and
a video playing module, configured to play the short video, and jump to a partner interface to play the partner long video based on the playback information of the partner long video.

In one embodiment, the information receiving module is specifically configured to:
send a first video information acquisition request to a server based on a playing request of a user for the short video; and
receive the short video and the playback information of the partner long video onto which the short video is mapped fed back by the server.

In one embodiment, the information receiving module is specifically configured to:
send a second video information acquisition request to a server based on a playing request of a user for the short video;
receive the short video fed back by the server;
send a third video information acquisition request to the server in the process of playing the short video; and
receive the playback information of the partner long video onto which the short video is mapped fed back by the server.

In one embodiment, the apparatus further comprises a partner long video play trigger module, configured to:
in the process of playing the short video, receive a playing request of a user for the partner long video onto which the short video is mapped.

In one embodiment, the playback information of the partner long video comprises a playback address of the partner long video and a playback position of the partner long video.

In one embodiment, the video playing module is specifically configured for:
determining a page type and a page address of a partner long video playing page by parsing the playback information of the partner long video;
based on the page type of the partner long video playing page, launching the partner interface in a form of a partner client or a partner H5 page within a client currently being used; and
sending the page address of the partner long video playing page and the playback information of the partner long video to the partner interface, so that the partner interface plays the partner long video based on the page address of the partner long video playing page and the playback information of the partner long video.

In one embodiment, the disclosure provides a video playing apparatus, arranged in a server, comprising:
an information determining module, configured to determine playback information of a partner long video mapped onto a short video to be played; and
an information sending module, configured to send the short video and the playback information of the partner long video onto which the short video is mapped to a client, so that the client plays the short video and jumps to a partner interface to play the partner long video based on the playback information of the partner long video.

In one embodiment, the information sending module is specifically configured for:
based on a first video information acquisition request sent by the client, sending the short video and the playback information of the partner long video onto which the short video is mapped to the client.

In one embodiment, the information sending module is specifically configured for:
based on a second video information acquisition request sent by the client, sending the short video to the client; and
based on a third video information acquisition request sent by the client in the process of playing the short video, sending the playback information of the partner long video onto which the short video is mapped to the client.

In one embodiment, information determining module comprises:
a mapping information module, configured to determine mapping information of the short video in a partner long video album based on mapping information of the short video in a local long video album and a first episode association relationship between the local long video album and the partner long video album; and
a playback information module, configured to determine the playback information of the partner long video onto which the short video is mapped based on the mapping information of the short video in the partner long video album.

In one embodiment, the mapping information of the short video in the partner long video album comprises an episode, to which the short video belongs, in the partner long video album and a position in the episode, and wherein a long video corresponding to the episode, to which the short video belongs, in the partner long video album is the partner long video.

In one embodiment, the playback information of the partner long video comprises a playback address of the partner long video and a playback position of the partner long video; and
the playback information module comprises a playback address sub-module, configured for:
determining the playback address of the partner long video based on the episode, to which the short video belongs, in the partner long video album and media asset information of the partner long video album, and
the playback information module comprises a playback position sub-module, configured for:
determining the playback position of the partner long video based on the mapping information of the short video in the partner long video album, which comprises:
determining a matching degree between the short video and the partner long video, and
determining the playback position of the partner long video based on the matching degree between the short video and the partner long video and the position of the short video in the partner long video.

In one embodiment, the playback position sub-module is specifically configured for:
if the matching degree between the short video and the partner long video is greater than or equal to a matching degree threshold, determining the playback position of the partner long video as a position after an initial position of the short video in the partner long video and separated from the initial position by a length of time the short video has been played; or
determining the playback position of the partner long video as the initial position of the short video in the partner long video.

In one embodiment, the playback position sub-module is specifically configured for:
determining a local long video matched with the partner long video; and
determining a matching degree between the short video and the local long video as the matching degree between the short video and the partner long video.

In one embodiment, in the process of playing the short video by the client, when a request of the user for playing the partner long video onto which the short video is mapped is received, the step of jumping to the partner interface to play the partner long video based on the playback information of the partner long video is performed.

In one embodiment, the disclosure provides an electronic device, comprising:
a processor; and
a memory storing instructions executable by the processor; wherein
the processor is configured to read the instructions from the memory and execute the instructions to perform the method according to any one of embodiments provided by the disclosure.

In one embodiment, the disclosure provides a computer-readable storage medium, storing program instructions that upon execution by a computing device, cause the computing device to perform the method according to any one of embodiments provided by the disclosure.

The above description is only a preferred embodiment of the disclosure and an explanation of the applied technical principles. Those skilled in the art should understand that the scope of disclosure involved in this disclosure is not limited to the technical solutions formed by the specific combination of the above technical features, and should also cover other technical solutions formed by any combination of the above technical features or their equivalent features without departing from the above disclosed concept. For example, the above-mentioned features and the technical features disclosed in (but not limited to) the disclosure having similar functions are replaced with each other to form a technical solution.

In addition, although the operations are depicted in a specific order, it should not be understood as requiring these operations to be performed in the specific order shown or performed in a sequential order. Under certain circumstances, multitasking and parallel processing may be advantageous. Likewise, although several specific implementation details are included in the above discussion, these should not be construed as limiting the scope of the disclosure. Certain features that are described in the context of separate embodiments may also be implemented in combination in a single embodiment. Conversely, various features that are described in the context of a single embodiment may also be implemented in multiple implementations individually or in any suitable sub-combination.

Although the subject matter has been described in a language specific to structural features and/or logical actions of the method, it should be understood that the subject matter defined in the appended claims is not necessarily limited to the specific features or actions described above. On the contrary, the specific features and actions described above are merely exemplary forms of implementing the claims.

1. A video playing method, comprising:
receiving a short video to be played and playback information of a partner long video onto which the short video is mapped; and
playing the short video, and jumping to a partner interface to play the partner long video based on the playback information of the partner long video.

2. The method according to claim 1, wherein the receiving a short video to be played and playback information of the partner long video onto which the short video is mapped comprises:
sending a first video information acquisition request to a server based on a playing request of a user for the short video; and
receiving the short video and the playback information of the partner long video onto which the short video is mapped fed back by the server.

3. The method according to claim 1, wherein the receiving a short video to be played and playback information of the partner long video onto which the short video is mapped comprises:
sending a second video information acquisition request to a server based on a playing request of a user for the short video;
receiving the short video fed back by the server;
sending a third video information acquisition request to the server in the process of playing the short video; and
receiving the playback information of the partner long video onto which the short video is mapped fed back by the server.

4. The method according to claim 1, before the jumping to a partner interface to play the partner long video based on the playback information of the partner long video, further comprising:
in the process of playing the short video, receiving a playing request of a user for the partner long video onto which the short video is mapped.

5. The method according to claim 1, wherein the playback information of the partner long video comprises a playback address of the partner long video and a playback position of the partner long video.

6. The method according to claim 1, wherein the jumping to a partner interface to play the partner long video based on the playback information comprises:
determining a page type and a page address of a partner long video playing page by parsing the playback information of the partner long video;
based on the page type of the partner long video playing page, launching the partner interface in a form of a partner client or a partner page within a client currently being used; and
sending the page address of the partner long video playing page and the playback information of the partner long video to the partner interface, so that the partner interface plays the partner long video based on the page address of the partner long video playing page and the playback information of the partner long video.

7. A video playing method, comprising:
determining playback information of a partner long video mapped onto a short video to be played; and
sending the short video and the playback information of the partner long video onto which the short video is mapped to a client, so that the client plays the short video and jumps to a partner interface to play the partner long video based on the playback information of the partner long video.

8. The method according to claim 7, wherein the sending the short video and the playback information of the partner long video onto which the short video is mapped to a client comprises:
based on a first video information acquisition request sent by the client, sending the short video and the playback information of the partner long video onto which the short video is mapped to the client.

9. The method according to claim 7, wherein the sending the short video and the playback information of the partner long video onto which the short video is mapped to a client comprises:
based on a second video information acquisition request sent by the client, sending the short video to the client; and
based on a third video information acquisition request sent by the client in the process of playing the short video, sending the playback information of the partner long video onto which the short video is mapped to the client.

10. The method according to claim 7, wherein the determining playback information of a partner long video mapped onto a short video to be played comprises:
determining mapping information of the short video in a partner long video album based on mapping information of the short video in a local long video album and a first episode association relationship between the local long video album and the partner long video album; and
determining the playback information of the partner long video onto which the short video is mapped based on the mapping information of the short video in the partner long video album.

11. The method according to claim 10, wherein the mapping information of the short video in the partner long video album comprises an episode, to which the short video belongs, in the partner long video album and a position in the episode, and wherein a long video corresponding to the episode, to which the short video belongs, in the partner long video album is the partner long video.

12. The method according to claim 11, wherein the playback information of the partner long video comprises a playback address of the partner long video and a playback position of the partner long video,
wherein determining the playback address of the partner long video based on the mapping information of the short video in the partner long video album comprises: determining the playback address of the partner long video based on the episode, to which the short video belongs, in the partner long video album and media asset information of the partner long video album, and
wherein determining the playback position of the partner long video based on the mapping information of the short video in the partner long video album comprises: determining a matching degree between the short video and the partner long video, and determining the playback position of the partner long video based on the matching degree between the short video and the partner long video and the position of the short video in the partner long video.

13. The method according to claim 12, wherein the determining the playback position of the partner long video based on the matching degree between the short video and the partner long video and the position of the short video in the partner long video comprises:
if the matching degree between the short video and the partner long video is greater than or equal to a matching degree threshold, determining the playback position of the partner long video as a position after an initial position of the short video in the partner long video and separated from the initial position by a length of time the short video has been played; or
determining the playback position of the partner long video as the initial position of the short video in the partner long video.

14. The method according to claim 12, wherein the determining a matching degree between the short video and the partner long video comprises:
determining a local long video matched with the partner long video; and
determining a matching degree between the short video and the local long video as the matching degree between the short video and the partner long video.

15. The method according to claim 7, wherein in the process of playing the short video by the client, when a request of the user for playing the partner long video onto which the short video is mapped is received, the step of jumping to the partner interface to play the partner long video based on the playback information of the partner long video is performed.

16. A video playing apparatus, comprising:
at least one processor; and
at least one memory communicatively coupled to the at least one processor and storing instructions that upon execution by the at least one processor cause the apparatus to:
receive a short video to be played and playback information of a partner long video onto which the short video is mapped; and
play the short video, and jump to a partner interface to play the partner long video based on the playback information of the partner long video.

17. A video playing apparatus, comprising:
at least one processor; and
at least one memory communicatively coupled to the at least one processor and storing instructions that upon execution by the at least one processor cause the apparatus to:
determine playback information of a partner long video mapped onto a short video to be played; and
send the short video and the playback information of the partner long video onto which the short video is mapped to a client, so that the client plays the short video and jumps to a partner interface to play the partner long video based on the playback information of the partner long video.

18. (canceled)

19. (canceled)
